(19) United States
(12) Patent Application Publication
(10) Pub. No.: US 2020/0343602 A1
(43) Pub. Date: Oct. 29, 2020

(54) APPARATUS FOR COOLING BATTERY FOR VEHICLE

(71) Applicants: Hyundai Motor Company, Seoul (KR); Kia Motors Corporation, Seoul (KR)

(72) Inventor: Gun Goo Lee, Suwon (KR)

(21) Appl. No.: 16/591,265

(22) Filed: Oct. 2, 2019

(30) Foreign Application Priority Data
Apr. 26, 2019 (KR) 10-2019-0048912

(51) Int. Cl. H01M 10/613; H01M 10/625; H01M 10/653; H01M 10/6567; H01M 10/6556; H01M 2/10

(52) U.S. Cl. CPC H01M 10/613; H01M 10/625; H01M 10/653; H01M 2220/20; H01M 10/6556; H01M 2/1077; H01M 10/6567

(57) ABSTRACT

An apparatus is provided to cool a battery for a vehicle. The apparatus includes a plurality of battery cells that are disposed adjacent to each other and at least one heat-exchange member into which the battery cells are inserted. The heat-exchange member exchanges. A cooling member is disposed below the heat-exchange member and exchanges heat with the heat-exchange member to cool the battery cells.

### CROSS-REFERENCE TO RELATED APPLICATION

This application claims the priority benefit of Korean Patent Application No. 10-2019-0048912, filed on Apr. 26, 2019, the disclosure of which is incorporated herein by reference.

### BACKGROUND

### 1. Field of the Invention

The present invention relates to an apparatus for cooling a battery for a vehicle, and more particularly, to an apparatus for cooling a vehicle battery, which simplifies the structure of a battery module and improves cooling performance.

### 2. Description of the Related Art

As electric vehicles and hybrid electric vehicles become more popular, batteries for use in these vehicles are increasingly being developed. Research is being conducted regarding the capacity of the battery and also regarding factors influencing the operational efficiency and the lifespan of the battery. In general, a high-voltage and high-capacity battery, which is used in electric vehicles or hybrid electric vehicles, includes battery packs, each of which includes a plurality of battery cells. In other words, a plurality of battery packs form an entire battery.

Since the battery packs are installed together in a restricted space, high-temperature heat is generated in the battery packs, which has an adverse influence on the lifespan of the entire battery. Therefore, it is necessary to construct a cooling system for adjusting the temperature of a high-voltage and high-capacity battery for use in electric vehicles or hybrid electric vehicles. In general, methods of cooling a high-voltage and high-capacity battery for a vehicle are classified into an air-cooling method and a water-cooling method. Further, each of the air-cooling method and the water-cooling method is classified into an indirect cooling method and a direct cooling method.

Conventionally, as shown in FIG. 1 of the related art, a battery system is cooled using an indirect water-cooling method. Specifically, referring to FIG. 1, heat-dissipating plates 2, which are in surface contact with battery cells 1, absorb heat emitted from the battery cells 1 and transfer the heat to a thermal interface material (TIM) 3. The TIM 3 exchanges heat with cooling water flowing through a cooling water channel 4, thereby cooling the battery cells 1. However, since the conventional battery pack includes the battery cells 1 assembled to cell cartridges 5 and a plurality of cell modules assembled to the cell cartridges 5 are stacked, the weight and the volume of the entire battery pack increase, and the manufacturing costs thereof increase.

The information disclosed in this section is merely for enhancement of understanding of the general background of the invention and should not be taken as an acknowledgement or any form of suggestion that this information forms the prior art already known to a person skilled in the art.

### SUMMARY

Therefore, the present invention provides an apparatus for cooling a battery for a vehicle, in which battery cells are inserted into heat-exchange members without using a frame, such as a cell cartridge or a cell case, thereby simplifying the overall structure of a battery module and reducing manufacturing costs.

In accordance with the present invention, the above and other objects may be accomplished by the provision of an apparatus for cooling a battery for a vehicle, that may include a plurality of battery cells disposed adjacent to each other, at least one heat-exchange member formed into which the battery cells may be inserted, the heat-exchange member exchanging heat with the battery cells, and a cooling member disposed below the heat-exchange member, the cooling member exchanging heat with the heat-exchange member to cool the battery cells.

The heat-exchange member may include an open top surface, a first side surface, a second side surface, and a bottom surface. The heat-exchange member may be formed in a “U” shape. The apparatus may further include a thermally conductive filler disposed in a gap between the battery cells and the bottom surface of the heat-exchange member and a thermal interface material (TIM) disposed between the bottom surface of the heat-exchange member and the top surface of the cooling member.

The apparatus may further include a first pad inserted between adjacent ones of the battery cells, and the first pad may apply surface pressure to each of the battery cells. The at least one heat-exchange member may include a plurality of stacked heat-exchange members. Additionally, the apparatus may include a second pad inserted between the heat-exchange members, and the second pad may apply surface pressure to each of the battery cells. One of a thermal grease, a thermal interface material (TIM), and a double-sided adhesive may be disposed between the first side surface of the heat-exchange member and one of the battery cells that is in surface contact with the first side surface.

One of a thermal grease, a thermal interface material (TIM), and a double-sided adhesive may be disposed between the second side surface of the heat-exchange member and one of the battery cells that is in surface contact with the second side surface. Additionally, one of a thermal grease, a thermal interface material (TIM), and a double-sided adhesive may be disposed between adjacent ones of the battery cells.

The apparatus may further include a cover that covers the top surface of the heat-exchange member and end plates disposed outside one outermost heat-exchange member and an opposite outermost heat-exchange member among the stacked heat-exchange members. Cooling water may flow through the cooling member, and the heat-exchange member may exchange heat with the cooling water to cool the battery cells.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view schematically showing a conventional apparatus for cooling a battery for a vehicle according to the related art;

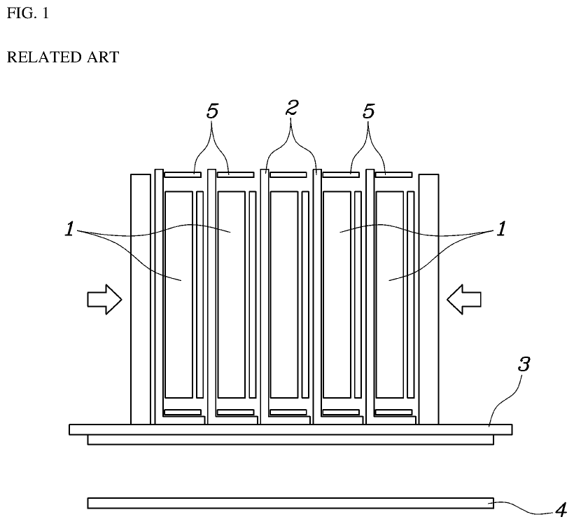

FIG. 2 is a view showing an apparatus for cooling a battery for a vehicle according to an exemplary embodiment of the present invention;

FIG. 3 is a cross-sectional view taken along line A-A′ in FIG. 2 according to an exemplary embodiment of the present invention;

FIG. 4 is a cross-sectional view of an apparatus for cooling a battery for a vehicle according to another exemplary embodiment of the present invention; and

FIG. 5 is a view showing the results of analysis of heat flow in the apparatus for cooling a battery for a vehicle according to the exemplary embodiment of the present invention and a conventional battery-cooling apparatus.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Reference will now be made in detail to the exemplary embodiments of the present invention, examples of which are illustrated in the accompanying drawings. Wherever possible, the same reference numbers will be used throughout the drawings to refer to the same or like parts.

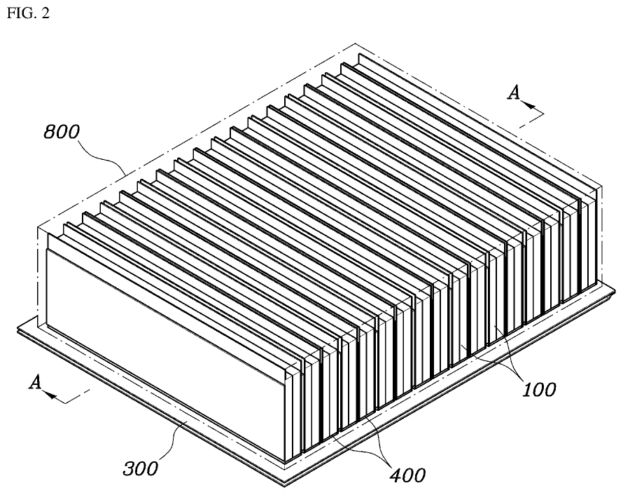

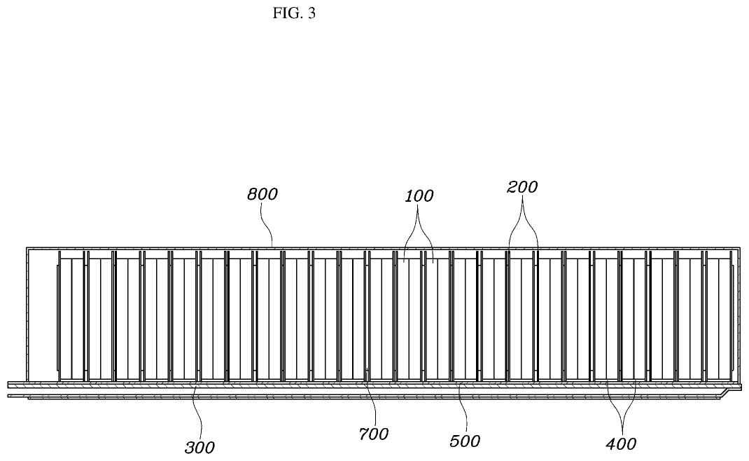

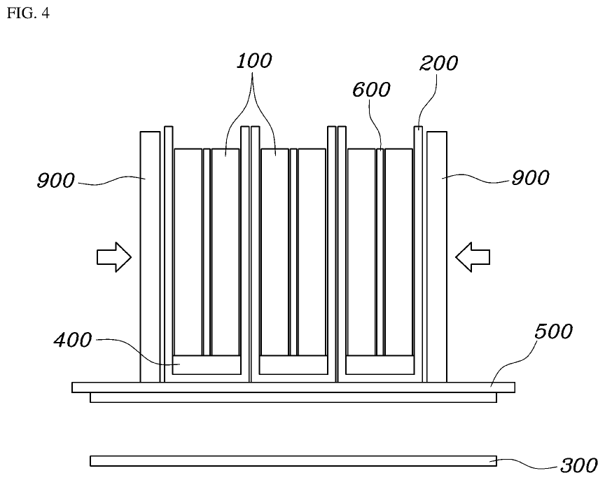

FIG. 2 is a view showing an apparatus for cooling a battery for a vehicle according to an exemplary embodiment of the present invention, FIG. 3 is a cross-sectional view taken along line A-A′ in FIG. 2, and FIG. 4 is a cross-sectional view of an apparatus for cooling a battery for a vehicle according to another exemplary embodiment of the present invention.

As shown in FIG. 2, an apparatus for cooling a battery for a vehicle according to an exemplary embodiment of the present invention may include battery cells 100, heat-exchange members 200, and a cooling member 300. The apparatus may further include at least one of thermally conductive fillers 400, a thermal interface material 500, first pads 600, second pads 700, a cover 800, or end plates 900.

Specifically, the apparatus for cooling a battery for a vehicle according to the present invention may include a plurality of battery cells 100 disposed adjacent to each other. The battery cells 100 may be stacked in close surface contact with each other (e.g., abutting surface contact) to apply uniform surface pressure to the respective battery cells 100. Depending on the exemplary embodiment, the first pads 600 may be inserted between the battery cells 100 to apply uniform surface pressure to the battery cells 100. Further, any one of a thermal grease, a thermal interface material (TIM), and a double-sided adhesive may be disposed between adjacent ones of the battery cells 100.

As shown in FIGS. 2 to 4, the battery cells 100 may be inserted into the heat-exchange members 200, and the heat-exchange members 200 may exchange heat with the battery cells 100 inserted thereinto. A plurality of heat-exchange members 200 may be stacked, and second pads 700 may be inserted between the stacked heat-exchange members 200 to apply surface pressure to the respective battery cells 100. Further, the heat-exchange members 200 may be formed of a material having excellent thermal conductivity. Depending on the exemplary embodiment, the heat-exchange members 200 may be heat-dissipating plates, which are formed of an aluminum material.

Conventionally, each battery cell 100 is assembled to a frame, such as a cell cartridge (not shown) or a cell case (not shown). However, according to the present invention, the battery cells 100 may be inserted into the heat-exchange members 200 without using a frame, such as a cell cartridge or a cell case, thereby simplifying the overall structure of the battery module and reducing manufacturing costs.

Specifically, each of the heat-exchange members 200 may include an open top surface, a first side surface 210, a second side surface 220, and a bottom surface 230. Depending on the exemplary embodiment, each of the heat-exchange members 200 may be formed in a “U” shape. In particular, as shown in FIGS. 3 and 4, the thermally conductive fillers 400 may be disposed in the gap between the battery cells 100 and the bottom surfaces 230 of the heat-exchange members. The thermally conductive fillers 400 are in close contact with the battery cells 100 and with the bottom surfaces 230 of the heat-exchange members and thus, the gaps defined between the battery cells 100 and the bottom surfaces 230 of the heat-exchange members may be completely filled with the thermally conductive fillers 400, thus more effectively transferring the heat generated in the battery cells 100 to the heat-exchange members 200.

In addition, any one of a thermal grease, a thermal interface material (TIM), and a double-sided adhesive may be disposed between the first side surfaces 210 of the heat-exchange members 200 and the battery cells 100 that are in surface contact with the first side surfaces 210. Any one of a thermal grease, a thermal interface material (TIM), and a double-sided adhesive may be disposed between the second side surfaces 220 of the heat-exchange members 200 and the battery cells 100 that are in surface contact with the second side surfaces 220.

In the present invention, the heat-exchange members 200 may be configured to cool the battery cells 100 by absorbing heat generated in the battery cells 100 inserted thereinto and dissipating the heat to the cooling member 300, which will be described later. Particularly, to increase the efficiency of cooling the battery cells 100, the heat generated in the battery cells 100 needs to be smoothly transferred to the heat-exchange members 200. Accordingly, as described above, the thermally conductive fillers 400 may be inserted between the battery cells 100 and the bottom surfaces 230 of the heat-exchange members.

In addition, a thermal grease or a thermal interface material may be disposed between the first side surfaces 210 of the heat-exchange members 200 and the battery cells 100 that are in surface contact with the first side surfaces 210, thus improving thermal conductivity between the battery cells 100 and the heat-exchange members 200. According to another exemplary embodiment, a double-sided adhesive may be disposed between the first side surfaces 210 of the heat-exchange members 200 and the battery cells 100 that are in surface contact with the first side surfaces 210, thereby more stably securing the battery cells 100 to the heat-exchange members 200.

The cooling member 300 may be disposed below the heat-exchange members 200, and may be configured to exchange heat with the heat-exchange members 200 to cool the battery cells 100. Specifically, cooling water may flow through the cooling member 300, and the heat-exchange members 200 may be configured to cool the battery cells 100 by exchanging heat transferred from the battery cells 100 with the cooling water.

Further, referring to FIG. 3, the apparatus for cooling a battery for a vehicle according to the exemplary embodiment of the present invention may include a thermal interface material (TIM) 500, disposed between the bottom surfaces 230 of the heat-exchange members and the cooling member 300. The thermal interface material 500 disposed between the bottom surfaces 230 of the heat-exchange members and the cooling member 300 may realize more effective heat transfer between the heat-exchange members 200 and the cooling member 300, thus leading to an improvement in the cooling performance of the battery cells 100.

The cover 800 may cover the open top surfaces of the heat-exchange members. Depending on the exemplary embodiment, the cover 800 may be formed of a plastic material or a metal material. However, the present invention is not limited as to the specific material of the cover 800. Various other materials may be used for the cover 800 according to the present invention. The end plates 900 may be disposed outside one outermost heat-exchange member 200 and the opposite outermost heat-exchange member 200 among the heat-exchange members 200 stacked as shown in FIGS. 2 and 3. The end plates 900 may support the heat-exchange members 200 and the battery cells 100.

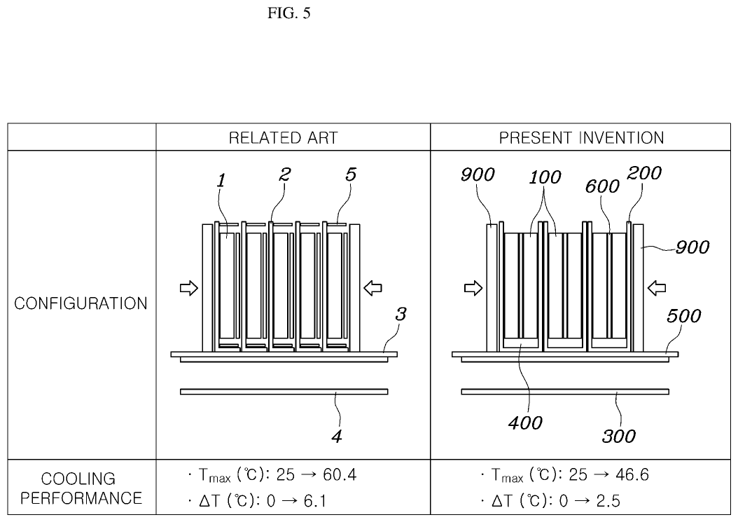

FIG. 5 is a view showing the results of analysis of heat flow in the apparatus for cooling a battery for a vehicle according to the exemplary embodiment of the present invention and the conventional battery-cooling apparatus. Referring to FIG. 5, compared to the conventional battery-cooling apparatus, the apparatus for cooling a battery for a vehicle according to the exemplary embodiment of the present invention may substantially reduce the maximum temperature that the heat generated in the battery cells reaches, and substantially reduce the rate of change in the temperature of the battery cells, which varies as the battery cells generate heat and are cooled.

As is apparent from the above description, the present invention provides an apparatus for cooling a battery for a vehicle, in which battery cells may be inserted into heat-exchange members without using a frame, such as a cell cartridge or a cell case, thereby simplifying the overall structure of a battery module and reducing manufacturing costs.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for cooling a battery for a vehicle, comprising:
a plurality of battery cells disposed adjacent to each other;
at least one heat-exchange member in which the battery cells are inserted, wherein the heat-exchange member exchanges heat with the battery cells; and
a cooling member disposed below the heat-exchange member, wherein the cooling member exchanges heat with the heat-exchange member to cool the battery cells.

2. The apparatus according to claim 1, wherein the heat-exchange member includes an open top surface, a first side surface, a second side surface, and a bottom surface.

3. The apparatus according to claim 1, wherein the heat-exchange member is formed in a U shape.

4. The apparatus according to claim 2, further comprising:
a thermally conductive filler disposed in a gap between the battery cells and the bottom surface of the heat-exchange member.

5. The apparatus according to claim 1, further comprising:
a thermal interface material (TIM) disposed between a bottom surface of the heat-exchange member and a top surface of the cooling member.

6. The apparatus according to claim 1, further comprising:
a first pad inserted between adjacent ones of the battery cells,
wherein the first pad applies surface pressure to each of the battery cells.

7. The apparatus according to claim 1, wherein the at least one heat-exchange member includes:
a plurality of stacked heat-exchange members,
wherein the apparatus further includes a second pad inserted between the heat-exchange members and that applies surface pressure to each of the battery cells.

8. The apparatus according to claim 2, wherein one of a thermal grease, a thermal interface material (TIM), and a double-sided adhesive is disposed between the first side surface of the heat-exchange member and one of the battery cells that is in surface contact with the first side surface.

9. The apparatus according to claim 2, wherein one of a thermal grease, a thermal interface material (TIM), and a double-sided adhesive is disposed between the second side surface of the heat-exchange member and one of the battery cells that is in surface contact with the second side surface.

10. The apparatus according to claim 1, wherein one of a thermal grease, a thermal interface material (TIM), and a double-sided adhesive is disposed between adjacent ones of the battery cells.

11. The apparatus according to claim 2, further comprising:
a cover that covers the top surface of the heat-exchange member.

12. The apparatus according to claim 7, further comprising:
end plates disposed outside one outermost heat-exchange member and an opposite outermost heat-exchange member among the stacked heat-exchange members.

13. The apparatus according to claim 1, wherein cooling water flows through the cooling member, and the heat-exchange member exchanges heat with the cooling water to cool the battery cells.
